(19) United States
(12) Patent Application Publication
(10) Pub. No.: US 2023/0003838 A1
(43) Pub. Date: Jan. 5, 2023

(54) TIME-OF-FLIGHT (TOF) LASER CONTROL FOR ELECTRONIC DEVICES

(71) Applicant: Sony Semiconductor Solutions Corporation, Kanagawa (JP)

(72) Inventors: Jianming Xu, San Jose, CA (US); Sa Xiao, Valkenswaard (NL)

(21) Appl. No.: 17/363,643

(22) Filed: Jun. 30, 2021

(51) Int. Cl. G01S 7/484; H04N 13/254; G06K 9/00; G01S 7/48; G01S 17/86; G01S 17/894

(52) U.S. Cl. CPC G01S 7/484; H04N 13/254; G06K 9/00624; G06K 9/00362; G01S 7/4802; G01S 17/86; G01S 17/894

(57) ABSTRACT

Time-of-flight laser control for electronic devices. In one implementation, an electronic device includes a memory, a time-of-flight (TOF) sensor system including a TOF sensor, and a laser, and an electronic processor. The electronic processor is configured to control the laser to emit initial light pulses above a threshold emission level for a predetermined period of time, receive the depth information based on the initial light pulses emitted by the laser, determine whether a living object is in a nominal hazard zone of the laser based on the depth information, responsive to determining that the living object is not in the nominal hazard zone of the laser, control the laser to emit additional light pulses above the threshold emission level, wherein the laser has a specific laser classification, and wherein the threshold emission level is above an ANSI Z136.1 specification threshold emission level for the specific laser classification.

### BACKGROUND OF THE INVENTION

### 1. Field of the Invention

This application relates generally to time-of-flight (TOF) sensors. More specifically, this application relates to laser controls for electronic devices including TOF sensors.

### 2. Description of Related Art

Nowadays handheld device usage (e.g., mobile phones, tablets, top set controllers, etc.) is more popular than ever. To increase user satisfaction and improve handheld device performance, TOF sensor systems have been included in handheld devices. TOF sensor systems include a TOF sensor and a laser that issues a series of laser pulses. The TOF sensor uses the laser signal reflected from an object or scene to accurately generate depth information of the scene and distance between the electronic device and the target.

However, laser light poses safety risks to human beings, and the potential for eye damage is often the modality that requires the most stringent regulation for laser device use. In controlled environments, laser safety may be practiced via laser administration regulations (such as interlock inside laser device apparatus, etc.) and laser safety personal protection (such as wearing laser protection goggles, etc.).

Laser safety guidelines are specified in ANSI Z136.1 specification. Maximum Permissible Exposure (MPE (λ, T)) is the highest power or energy density of the laser source that is considered safe and has negligible probability of causing any damage to the eye. MPE values are the design criterion in laser safety control. MPE value is related to laser wavelength, laser emission power and the amount of laser exposure time to human beings.

Conventionally, a photoelectric signal time length is used as a criterion to determine laser working status or laser energy level. A preset time length threshold is used to turn off the laser if the measured time length exceeds the threshold value. However, the photoelectric signal time length does not clearly relate to laser eye safety class specification and calibration.

### BRIEF SUMMARY OF THE INVENTION

The present disclosure addresses the above-noted shortcomings and provides an implementation method that, preferably, is ANSI laser safety specification classified and calibrated. The present disclosure also addresses handheld devices TOF sensor system usage situations in uncontrolled environments.

Specifically, the present disclosure uses image processing and neural network logic to identify the presence of living objects (and in particular, living humans) in the scene. Coupled with an ambient light sensor to select eye pupil apertures, and parallel to TOF depth information measurement, the present disclosure achieves adaptable laser energy emission and laser safety control.

The assembly of the present disclosure is small in footprint and is a simple and cost-effective approach in TOF handheld device applications. The assembly of the present disclosure is also field upgradable due to data processing and control algorithms in an on-chip package, in an image signal processor package (ISP), in an electronic processor (e.g., a micro-processor or a micro-controller) on a local printed circuit board (PCB), or in a remote platform via a serial bus (e.g., I2C/SPI).

To achieve the best device performance under MPE specification consideration, the laser emission power and integration time is controlled to provide better image quality and accurate depth information measurement while complying with the ANSI Z136.1 specification. Various aspects of the present disclosure relate to TOF laser control for electronic devices.

In one aspect of the present disclosure, there is provided an electronic device comprising a memory, a time-of-flight (TOF) sensor system, and an electronic processor. The memory storing a list of laser classifications and corresponding maximum permissible exposure (MPE) values. The TOF sensor system including a TOF sensor configured to generate depth information from light reflected of one or more objects, and a laser configured to emit light pulses. The electronic processor is configured to control the laser to emit initial light pulses above a threshold emission level for a predetermined period of time, receive the depth information that is generated by the TOF sensor, the depth information based on the initial light pulses emitted by the laser, determine whether a living object is in a nominal hazard zone of the laser based on the depth information, responsive to determining that the living object is not in the nominal hazard zone of the laser, control the laser to emit additional light pulses above the threshold emission level, wherein the laser has a specific laser classification, and wherein the threshold emission level is above an ANSI Z136.1 specification threshold emission level for the specific laser classification.

In another aspect of the present disclosure, there is provided a method. The method includes controlling, with an electronic processor, a laser to emit initial light pulses above a threshold emission level for a predetermined period of time. The method includes receiving, with the electronic processor, depth information that is generated by a TOF sensor, the depth information based on the initial light pulses emitted by the laser. The method includes determining, with the electronic processor, whether a living object is in a nominal hazard zone of the laser based on the depth information. The method also includes responsive to determining that the living object is not in the nominal hazard zone of the laser, controlling, with the electronic processor, the laser to emit additional light pulses above the threshold emission level. The laser has a specific laser classification and the threshold emission level is above an ANSI Z136.1 specification threshold emission level for the specific laser classification.

In yet another aspect of the present disclosure, there is provided a non-transitory computer-readable medium. The set of operations includes controlling a laser to emit initial light pulses above a threshold emission level for a predetermined period of time. The set of operations includes receiving depth information that is generated by a TOF sensor, the depth information based on the initial light pulses emitted by the laser. The set of operations includes determining whether a living object is in a nominal hazard zone of the laser based on the depth information. The set of operations also includes responsive to determining that the living object is not in the nominal hazard zone of the laser, controlling the laser to emit additional light pulses above the threshold emission level. The laser has a specific laser classification and the threshold emission level is above an ANSI Z136.1 specification threshold emission level for the specific laser classification.

In this manner, the above aspects of the present disclosure provide for improvements in at least the technical field of imaging, as well as the related technical fields of signal processing, image processing, and the like.

This disclosure can be embodied in various forms, including hardware or circuits controlled by computer-implemented methods, computer program products, computer systems and networks, user interfaces, and application programming interfaces; as well as hardware-implemented methods, signal processing circuits, image sensor circuits, application specific integrated circuits, field programmable gate arrays, and the like. The foregoing summary is intended solely to give a general idea of various aspects of the present disclosure, and does not limit the scope of the disclosure in any way.

### DESCRIPTION OF THE DRAWINGS

These and other more detailed and specific features of various embodiments are more fully disclosed in the following description, reference being had to the accompanying drawings, in which:

FIG. 1 is block diagram that illustrates a time-of-flight (TOF) sensor environment, in accordance with various aspects of the present disclosure;

FIG. 2 is a block diagram that illustrates a process for monitoring the laser and laser control, in accordance with various aspects of the present disclosure;

FIG. 3 is a block diagram of illustrating a process that is a balanced approach between laser energy emission and laser safety control, in accordance with various aspects of the present disclosure;

FIG. 4 is a flowchart that illustrates a derivation of the allowable laser emission energy, in accordance with various aspects of the present disclosure;

FIG. 5 is a block diagram that illustrates a calibration of a TOF laser module L-I (laser light intensity vs. laser driver current) curve, in accordance with various aspects of the present disclosure;

FIG. 6 is a flowchart illustrating a process for laser current sensing and data acquisition and processing with the electronic device 100 of FIG. 1, in accordance with various aspects of the present disclosure;

FIG. 7 is a circuit diagram illustrating a first example of the current sensing apparatus 114 of FIG. 1, in accordance with various aspects of the present disclosure;

FIG. 8 is a circuit diagram illustrating a second example of the current sensing apparatus 114 of FIG. 1, in accordance with various aspects of the present disclosure;

FIG. 9 is a circuit diagram illustrating a third example of the current sensing apparatus 114 of FIG. 1, in accordance with various aspects of the present disclosure;

FIG. 10 is a circuit diagram illustrating an example of ambient light detection circuitry, in accordance with various aspects of the present disclosure;

FIG. 11 is a flowchart that illustrates a first example process of the data processing and laser safety control block in FIG. 2, in accordance with various aspects of the present disclosure;

FIG. 12 is a flowchart that illustrates a second example process of the data processing and laser safety control block in FIG. 2, in accordance with various aspects of the present disclosure;

FIGS. 13 and 14 are flowcharts illustrating examples of a neural network that determines whether a living object exists in a scene, in accordance with various aspects of the present disclosure; and

FIG. 15 is a flowchart that illustrates an example of the data processing and laser safety control performed by an off-chip electronic processor, in accordance with various aspects of the present disclosure.

### DETAILED DESCRIPTION

In the following description, numerous details are set forth, such as flowcharts, data tables, and system configurations. It will be readily apparent to one skilled in the art that these specific details are merely exemplary and not intended to limit the scope of this application.

Moreover, while the present disclosure focuses mainly on examples in which the processing circuits are used in mobile, it will be understood that this is merely one example of an implementation. It will further be understood that the disclosed systems and methods can be used in any device in which there is a need to perform laser safety with TOF sensors. Furthermore, the TOF sensor system implementations described below may be incorporated into an electronic apparatus, including but not limited to a smartphone, a tablet computer, a laptop computer, and the like.

TOF Sensor Environment

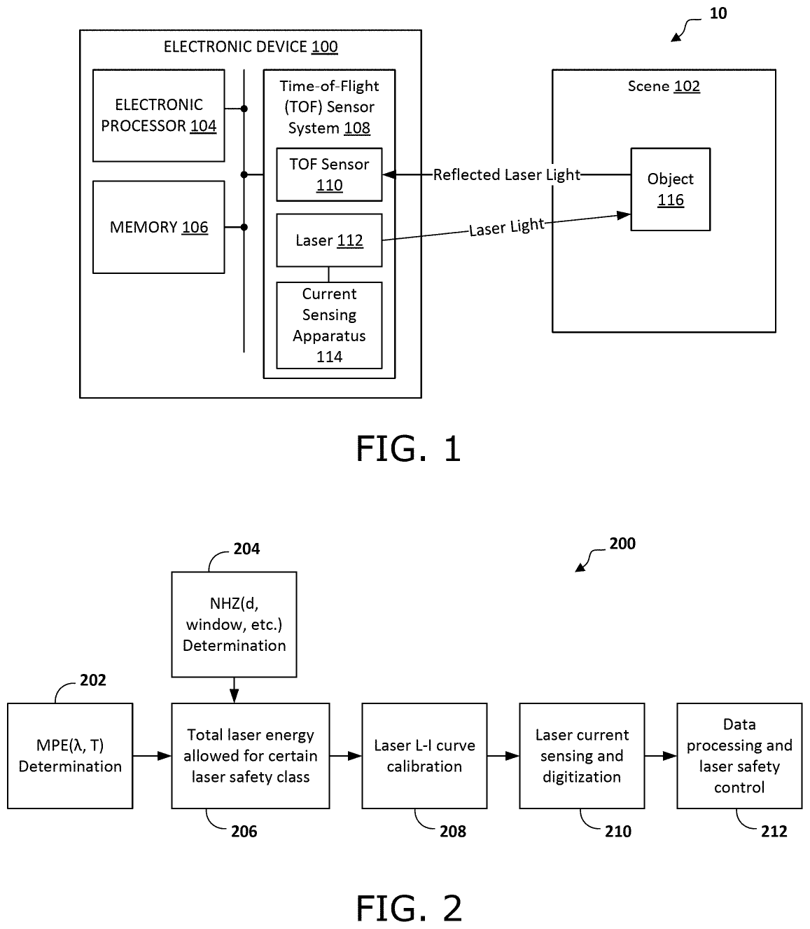

FIG. 1 is block diagram that illustrates a time-of-flight (TOF) sensor environment 10, in accordance with various aspects of the present disclosure. In the example of FIG. 1, the TOF sensor environment 10 includes an electronic device 100 and a scene 102. The electronic device 100 includes an electronic processor 104, a memory 106, and a TOF sensor system 108 including a TOF sensor 110, a laser 112, and a current sensing apparatus 114.

In some embodiments, the electronic device 100 may include fewer or additional components in configurations different from that illustrated in FIG. 1. Also, the electronic device 100 may perform additional functionality than the functionality described herein. In addition, the functionality of the electronic device 100 may be at least partly incorporated into a server or other electronic devices. As illustrated in FIG. 1, the electronic processor 104, the memory 106, and the TOF sensor system 106 are electrically coupled by one or more control or data buses enabling communication between the components.

The electronic processor 104 (e.g., microprocessor, application specification integrated circuit (ASIC), field-programmable gate array (FPGA), or other suitable electronic processor) executes machine-readable instructions stored in the memory 106. For example, the electronic processor 104 may execute instructions stored in the memory 106 to perform the functionality described herein.

The memory 106 may include a program storage area (for example, read only memory (ROM)) and a data storage area (for example, random access memory (RAM), and/or other non-transitory, machine-readable media). In some examples, the program storage area may store the instructions to perform some or all of the functions and processes described herein.

The TOF sensor system 108 includes a TOF sensor 110, a laser 112, and a current sensing apparatus 114. The TOF sensor 110 is configured to receive light pulses reflected off of an object and generate depth information between the electronic device 100 and the object. The laser 112 is configured to emit the light pulses that are reflected off the object. In some examples, the laser 112 may be a vertical-cavity surface-emitting laser (VCSEL), a single laser diode, or other single laser type. In other examples, the laser 112 may be a matrix laser or other multi-laser type. In yet other examples, the laser 112 is generally a semiconductor-based laser.

The current sensing apparatus 114 is configured to sense a laser current being used by the laser 112. The current sensing apparatus 114 is described and illustrated in greater detail below with respect to FIGS. 7-9.

The scene 102 includes an object 116. The object 116 may be a living object or a non-living object. When the object 116 is a living object, the object 116 may also be a living human or other living object that is not human (e.g., animals, trees, or other living objects that are not human).

Laser Safety Control

FIG. 2 is a block diagram that illustrates a process 200 for monitoring the laser and laser control, in accordance with various aspects of the present disclosure. In the example of FIG. 2, the process 200 includes a determination of maximum permissible exposure (MPE) process 202, a determination of nominal hazard zone process (NHZ) 204, a determination of total laser energy allowed for certain laser safety class process 206, a laser L-I curve calibration process 208, a laser current sensing and digitization process 210, and data processing and laser safety control process 212.

Input parameters are provided to the determination of MPE process 202 and the determination of NHZ process 204. In some examples, the input parameters may include laser safety class specification, laser characteristics (wavelength, beam diameter, divergence, laser duty cycle, laser maximum power, or other suitable laser characteristics), TOF optical path (diffuse or specular window and its attenuation), and/or limited eye pupil apertures corresponding to different ambient light situations.

The determination of MPE process 202 determines MPE values from the input parameters. The determination of NHZ process 204 determines the nominal hazard zone value from the input parameters. The determination of total laser energy allowed for certain laser safety class process 206 uses the MPE values that are determined and the NHZ that is determined. The determination of total laser energy allowed for certain laser safety class process 206 determines a tabulated exposure time and Maximum Permissible Exposure values. Specifically, the determination of total laser energy allowed for certain laser safety class process 206 outputs a tabulated total allowable laser energy values corresponding to certain (MPE (λ, T)) values under nominal hazard zone value and certain exposure time.

The laser L-I curve calibration process 208 calibrates function parameters for a light-current curve that characterizes the required emission properties of the laser 112 from the tabulated total allowable laser energy values corresponding to certain (MPE (λ, T)) values under nominal hazard zone value and certain exposure time.

The laser current sensing and digitization process 210 senses laser current with a current sensing apparatus within the TOF sensor and monitors laser driver current in real-time. The laser current sensing and digitization process 210 also digitizes the laser current and provides the digitized data to the electronic processor 104 for the data processing and laser safety control process 212. The electronic processor 104 receives the digitized data, image data, and TOF depth information to monitor and control laser light emission by the laser 112.

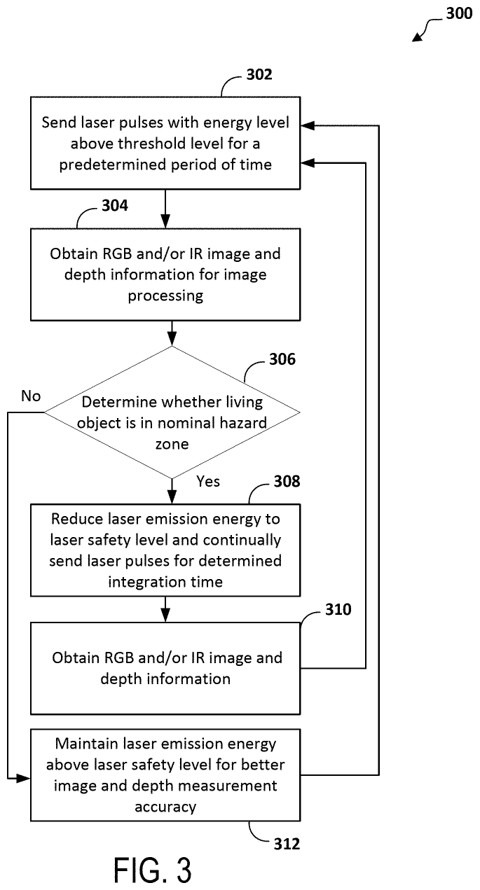

FIG. 3 is a block diagram of illustrating a process 300 that is a balanced approach between laser energy emission and laser safety control, in accordance with various aspects of the present disclosure. In the example of FIG. 3, the process 300 includes the laser 112 of FIG. 1 sending laser pulses with an energy level above a safety threshold level for a short time (at block 302). Even though the initial laser pulses have the energy level above the safety threshold, the short period of time (e.g., 100 microseconds) is preferably arranged to be short enough to maintain the total laser energy emitted to be well within the safety requirements set forth by the ANSI Z136.1 specification.

While sending the laser pulses (or shortly after), the process 300 includes the electronic processor 104 obtaining a red-green-blue (RGB) image and/or a near-infrared (near-IR) image for image processing (at block 304). Responsive to obtaining the RGB image and/or the near-IR image, the electronic processor 104 determines whether a living object is in the nominal hazard zone (decision block 306). For example, the electronic processor 104 performs image processing to identify the living object and determines whether the living object that is identified is in the nominal hazard zone.

Responsive to determining that the living object is in the nominal hazard zone (“YES” at decision block 306), the electronic processor 104 controls the laser 112 to reduce the laser emission energy to a laser safety level and continually send laser pulses at the reduced laser emission energy level for a determined integration time (at block 308). After the determined integration time expires, the electronic processor 104 controls the laser 112 to obtain the RGB image and/or IR image and depth information (at block 310) and then repeats the process 300 (at block 302). Responsive to determining that the living is not in the nominal hazard zone (“NO” at decision block 306), the electronic processor 104 controls the laser 112 to maintain the laser emission energy above the laser safety level for better image and depth measurement accuracy and until the setting integration time (i.e., the exposure time) is completed (at block 312) and then repeats the process 300 (at block 302).

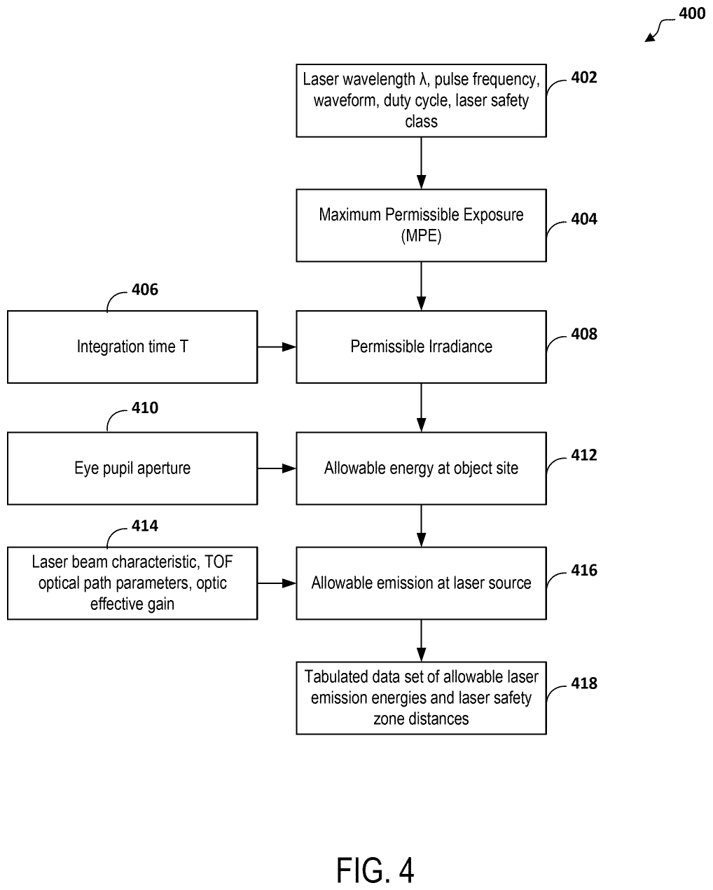

FIG. 4 is a flowchart that illustrates a derivation 400 of the allowable laser emission energy, in accordance with various aspects of the present disclosure. In the example of FIG. 4, the derivation 400 includes the electronic processor 104 determines a plurality of laser characteristics of the laser 112 (at block 402). For example, the electronic processor 104 determines the laser wavelength, the pulse frequency, waveform, duty cycle, and the laser safety class of the laser 112.

The derivation 400 includes the electronic processor 104 determining the MPE value after determining the laser wavelength, the laser pulse operation frequency, the laser safety class (at block 404).

After determining the MPE value, the electronic processor 104 determines a series of integration time (at block 406) and determines a series of laser permissible irradiances corresponding to the series of integration time T that is determined (at block 408).

After determining the series of laser permissible irradiances corresponding to the series of the integration time T, the electronic processor 104 determines eye pupil aperture parameters corresponding to different ambient light situations (at block 410) and determines a series of allowable laser emission energies at object site based on the eye pupil aperture parameters corresponding to different ambient light conditions and the series of permissible irradiances (at block 412).

After obtaining the series of allowable laser emission energies at the object site, the electronic processor 104 determines laser beam characteristics, TOF optical path parameters, and optic effective gain (at block 414) and determines a series of allowable laser emission energies at the laser 112 with the laser beam characteristics, the TOF module optical path parameters, and the optic effective gain (at block 416).

The electronic processor 104 outputs a tabulated data set of allowable laser emission energies and laser safety zone distances (at block 418). In some examples, the tabulated data set is stored in non-volatile memory for laser safety classification and laser emission energy control by the electronic processor 104.

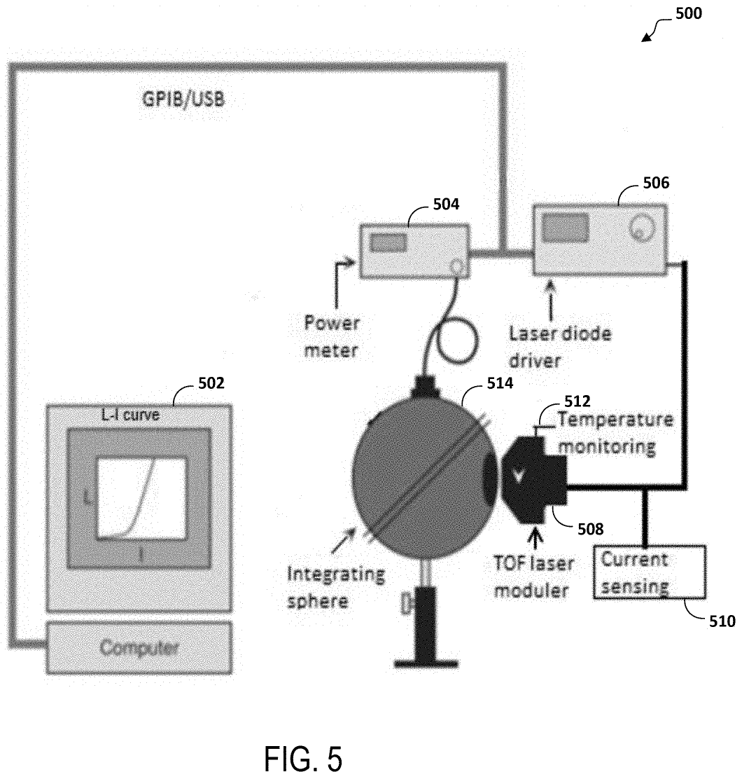

FIG. 5 is a block diagram that illustrates a calibration 500 of a TOF laser module L-I (laser light intensity vs. laser driver current) curve, in accordance with various aspects of the present disclosure. In the example of FIG. 5, the calibration 500 includes a computer 502, an optical power meter 504, a laser diode driver 506, a TOF laser 508, a current sensing apparatus 510, a temperature monitoring apparatus 512, and an integrating sphere 514.

The computer 502 controls the laser diode driver 506 to drive the TOF laser 508 to emit a range of light intensities while in parallel measuring the laser current with the current sensing apparatus 510 and the temperature with the temperature monitoring apparatus 512. The computer 502 also communicates with the optical power meter 504 to a collect a series of data corresponding to a range of light intensities emitted by the TOF laser 508 and diffused by the integrating sphere 514.

The computer 502 receives the range of light intensities measured by the optical power meter 504 and the corresponding laser currents measured by the current sensing apparatus 510. The computer 502 generates the L-I curve from the range of light intensities measured by the optical power meter 504 and the corresponding laser currents measured by the current sensing apparatus 510.

After the calibration 500, the L-I curve function parameters are stored in the memory 106 of the electronic device 100 for the purpose of laser safety monitoring and controlling. In the example of FIG. 1, the laser driver current is monitored by laser current sensing apparatus in the electronic device 100, along with an ambient light sensor for eye pupil aperture parameter selection in determining laser safety classification and laser emission energy control.

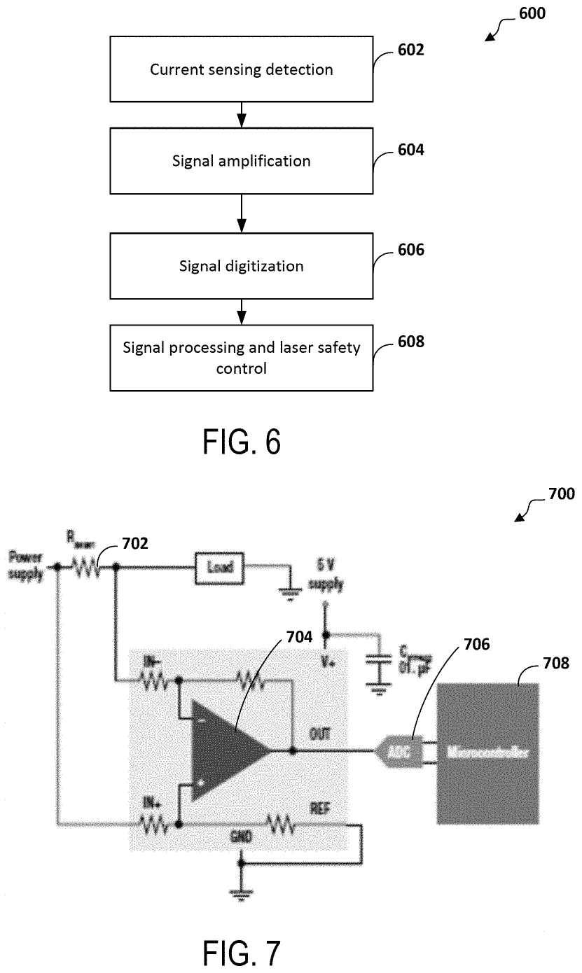

FIG. 6 is a flowchart illustrating a process for laser current sensing and data acquisition and processing with the electronic device 100 of FIG. 1, in accordance with various aspects of the present disclosure. In the example of FIG. 6, the process 600 includes current sensing detection 602, signal amplification 604, signal digitization 606, and signal processing and laser safety control 608.

The electronic device 100 uses the current sensing apparatus 114 to sense the laser current (at block 602). The electronic device 100 uses a signal amplifier to amplify the laser signal (at block 604). The electronic device 100 uses an analog-to-digital converter (ADC) to convert the amplified laser signal from an analog signal to a digital signal (at block 606). The electronic device 100 then performs signal processing and laser safety control based on the signal processing (at block 608).

FIG. 7 is a circuit diagram illustrating a first example 700 of the current sensing apparatus 114 of FIG. 1, in accordance with various aspects of the present disclosure. In the first example 700, the current sensing apparatus 114 is a single shunt resistor 702 connected to a signal amplifier 704 to convert the current-sensing resistor's differential signal to a single-ended signal. The output of amplifier 704 is sent to an analog-to-digital (ADC) 706 that is connected to a processor 708.

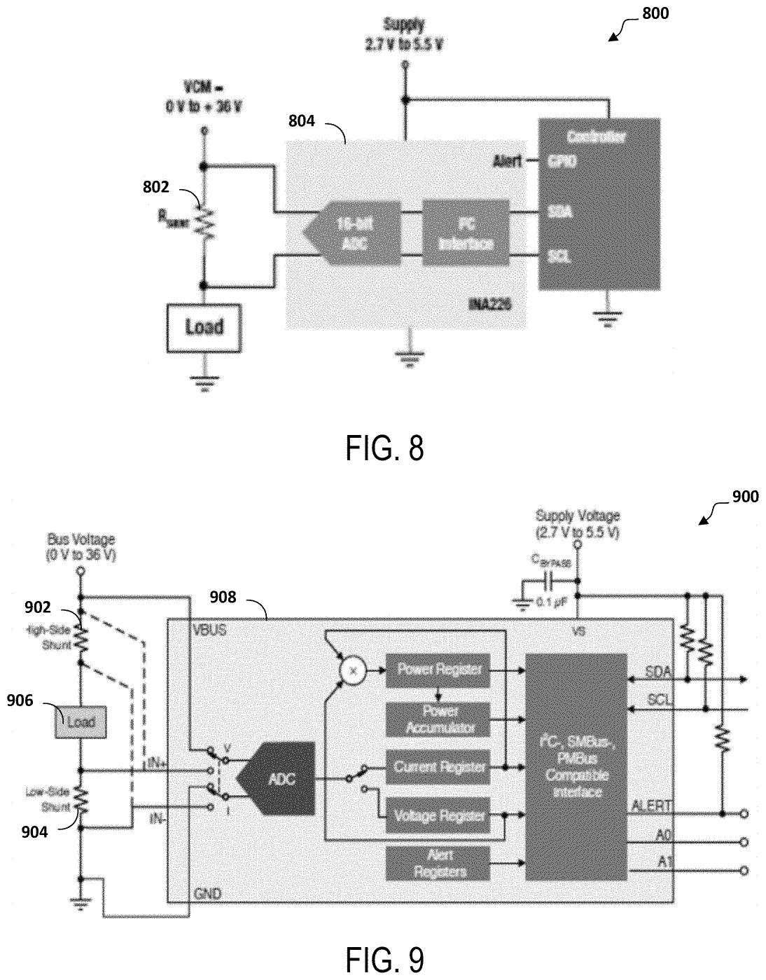

FIG. 8 is a circuit diagram illustrating a second example 800 of the current sensing apparatus 114 of FIG. 1, in accordance with various aspects of the present disclosure. In the second example 800, the current sensing apparatus 114 is a shunt resistor 802 connected to a digital current monitor (INA226) 804.

FIG. 9 is a circuit diagram illustrating a third example 900 of the current sensing apparatus 114 of FIG. 1, in accordance with various aspects of the present disclosure. In the third example 900, the current sensing apparatus 114 of FIG. 1 includes two shunt resistors 902 and 904, a load 906, and a current sensing integrating circuit 908 that handles the mathematical processing of current-sensing data accumulation and averaging, freeing up the processor (e.g., electronic processor 104) for other system tasks.

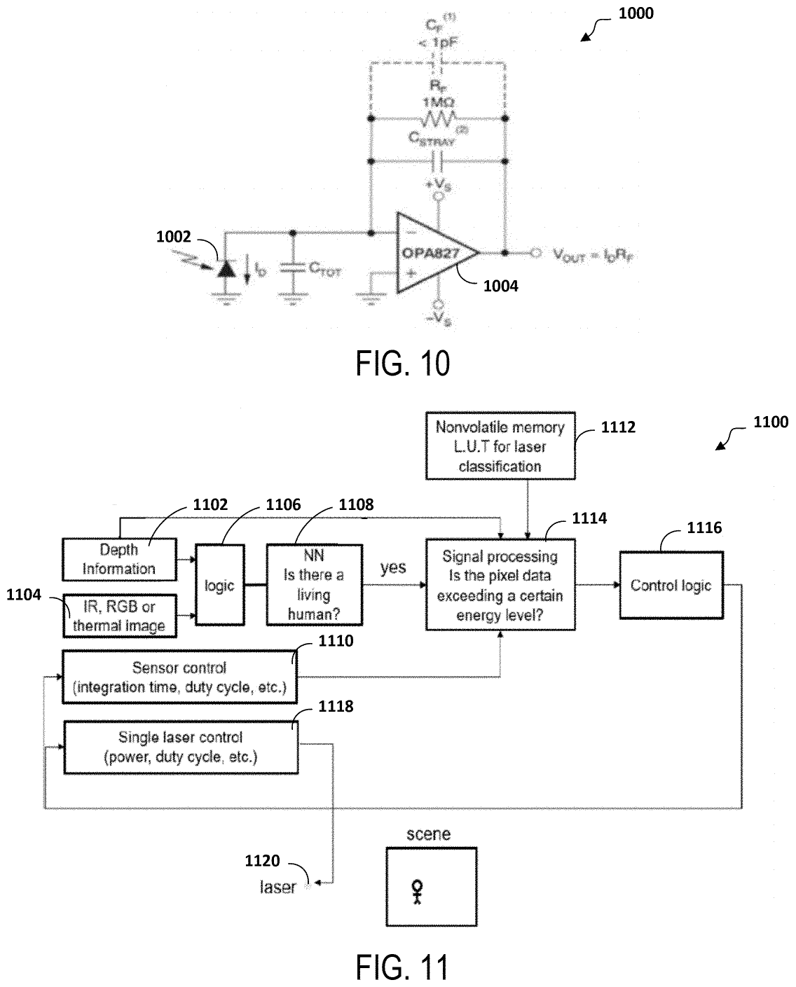

FIG. 10 is a circuit diagram illustrating an example of ambient light detection circuitry 1000, in accordance with various aspects of the present disclosure. In the example of FIG. 10, the ambient light detection circuitry 1000 includes a photodiode 1002 and transimpedance amplifier 1004 to convert the light signal from the photodiode 1002 to an analog voltage that may be further converted to a digital data with an analog-to-digital converter (ADC) and provided to an electronic processor for selection of corresponding eye pupil aperture stored in memory 106 of FIG. 1.

However, the ambient light detection circuitry 1000 is not limited to the above example. The ambient light detection circuitry 1000 may be any circuitry that detects ambient light. For example, the ambient light detection circuitry 1000 may be a TOF sensor (e.g., the TOF sensor 110 of FIG. 1) that uses one image frame without emitting laser light to detect the ambient light in the environment of the TOF sensor.

FIG. 11 is a flowchart that illustrates a first example process 1100 of the data processing and laser safety control block 212 in FIG. 2, in accordance with various aspects of the present disclosure. FIG. 11 is described with respect to the electronic processor 104 and the memory 106 of the electronic device 100 of FIG. 1.

In the first example 1100, the electronic processor 104 receives depth information (at block 1102). The electronic processor 104 may calculate depth information from the IR image, or receive the depth information from block 1102. While the electronic processor 104 calculates depth information, the depth information calculation by the electronic processor 104 may include a near-infrared (near-IR) image, a color (i.e., RGB) image, or a thermal image (at block 1104).

Responsive to receiving the depth information and the at least one of the near-IR image, the color image, or the thermal image, the electronic processor 104 uses logic (block 1106) to determine whether to use the depth information by itself or use the depth information in combination with at least one of the near-IR image, the color image, or the thermal image.

Responsive to determining whether to just use the depth information by itself or use the depth information in combination with the at least one of the near-IR image, the color image, or the thermal image, the electronic processor 104 uses a neural network (i.e., a pretrained model) to detect whether a living object is in a field-of-view (FOV) of the TOF sensor (at block 1108). For example, the electronic processor 104 uses the neural network to detect a living object with just the depth information. Additionally, in some examples, the electronic processor 104 uses the neural network to detect that the living object is a living human with the depth information and in combination with the at least one of the near-IR image, the color image, or the thermal image. The neural network may be pretrained to detect eye movement, gestures, or other suitable human characteristics to determine whether the living object is a living human or not.

Responsive to determining to that a living is in the FOV of the TOF sensor, the electronic processor 104, receives sensor control information from sensor control circuitry (block 1110), retrieves a look-up table from the memory 106 (block 1112), and performs signal processing to determine whether the pixel data exceeds a certain energy level set in the look-up table (at block 1114). The look-up table includes a list of laser classifications and corresponding safety laser emission levels.

Specifically, when the electronic processor 104 detects a living human with the neural network, the electronic processor 104 uses the depth information and the sensor control information to calculate the laser energy level on the human body surface (at block 1116). When the laser energy level exceeds a predefined level, the electronic processor 104 uses control logic (block 1116) to trigger the sensor control circuitry (block 1110) and single laser control circuitry (1118) to lower the emitted energy on the human surface.

The neural network, signal processing, and control logic may be on a single chip, a separate ISP chip, or an off-chip processor that is locally assembled on the PCB board of the TOF sensor system, or on an electronic device platform via serial communication, such as SPI or I2C bus. For example, the neural network and control logic may be stored in the memory 106 and the signal processing may be performed by the electronic processor 104.

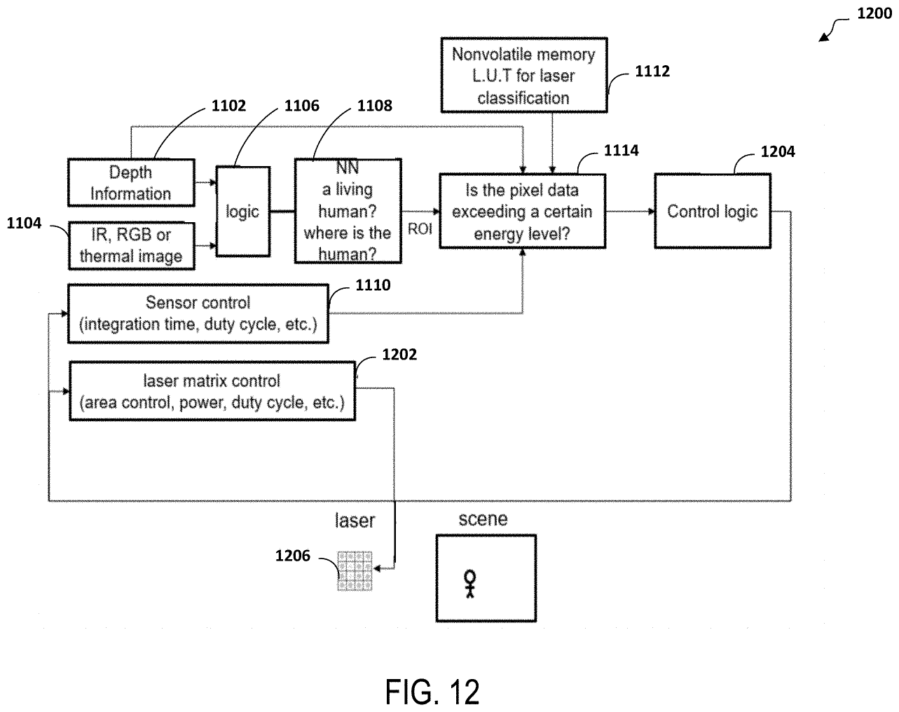

FIG. 12 is a flowchart that illustrates a second example process 1200 of the data processing and laser safety control block 212 in FIG. 2, in accordance with various aspects of the present disclosure. FIG. 12 is described with respect to the electronic processor 104 and the memory 106 of the electronic device 100 of FIG. 1.

FIG. 12 differs from FIG. 11 in that the single laser control 1118 of FIG. 11 is replaced with a laser matrix control 1202 that controls a matrix laser 1206 instead of the single laser 1120. The matrix laser 1206 includes a plurality of lasers instead of a single laser.

In the example of FIG. 12, when the electronic processor 104 determines that the laser energy level exceeds a predefined level at the certain detected living object location, the control logic (block 1204) will either trigger the sensor control circuitry 1110 or trigger the area control for the matrix laser 1206 (or the spot control lasers) at a certain location. This control by the electronic processor 104 will lower the emitted energy on a specific detected human surface while maintaining the emitted energy on non-human surfaces.

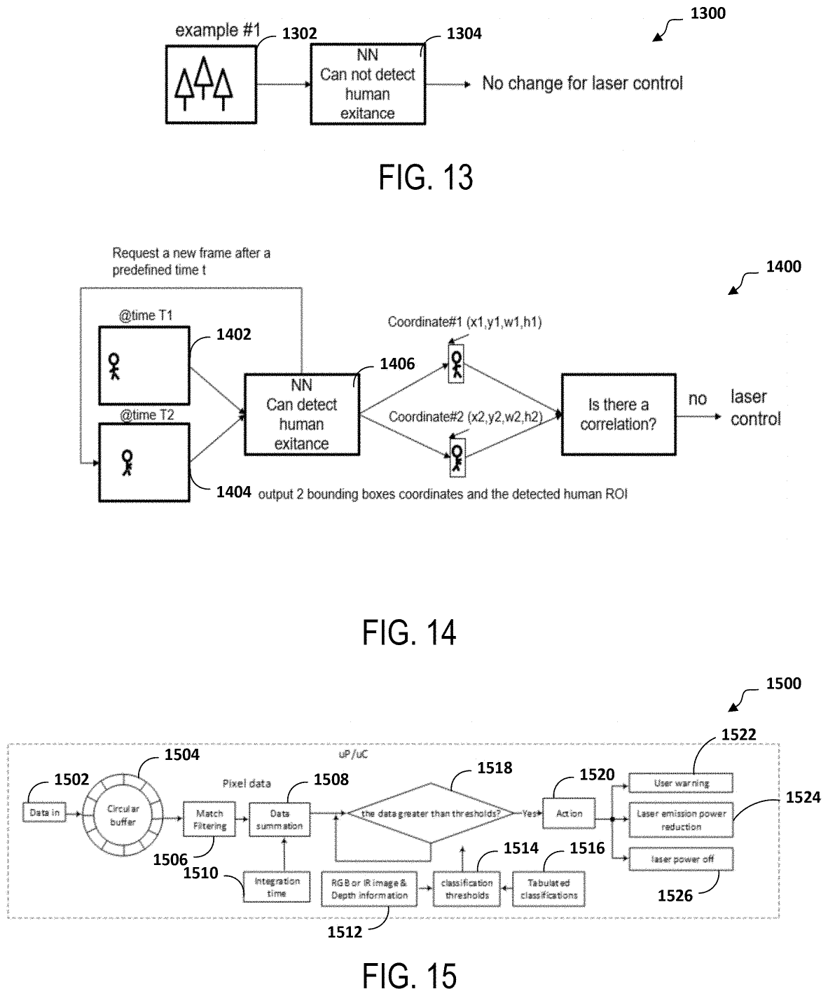

FIGS. 13 and 14 are flowcharts illustrating examples 1300 and 1400 of a neural network that determines whether a living object exists in a scene, in accordance with various aspects of the present disclosure. FIGS. 13 and 14 are described with respect to the electronic processor 104 and the memory 106 of the electronic device 100 of FIG. 1.

In the example 1300, the scene 1302 includes plurality of trees. While trees are living objects, trees are not living humans. Therefore, the electronic processor 104 does not detect any living humans in the scene 1302 with the neural network 1304. Consequently, the electronic processor 104 does change the emission level of the laser.

In the example 1400, the scene 1402 includes a person that moves in the scene 1404. Therefore, the electronic processor 104 does detect a living human in the scenes 1402 and 1404 with the neural network 1406. Consequently, the electronic processor 104 extracts the coordinates of the living human in the scenes 1402 and 1404 and outputs two bounding boxes coordinates and the detect human region-of-interest (ROI). In some examples, the electronic processor 104 may control the laser control circuitry to lower emissions of a portion of a plurality of lasers forming a matrix laser. The portion of the plurality of lasers corresponding to the lasers of the plurality of lasers that emit light at the bounding boxes coordinates.

Additionally, in some examples, the bounding boxes coordinates may be aligned with TOF depth information to determine whether the living human is approaching closer to TOF sensor or away from the TOF sensor. In some examples, when the living human is approaching the TOF sensor, the electronic processor 104 may control the laser to further reduce laser emissions. In other examples, when the living human is moving away from the TOF sensor, the electronic processor 104 may control the laser to maintain or increase laser emissions.

FIG. 15 is a flowchart that illustrates an example 1500 of the data processing and laser safety control performed by an off-chip electronic processor, in accordance with various aspects of the present disclosure. In the example 1500, the off-chip electronic processor accepts digitized current sensing data-in (block 1502) via a communication bus (e.g., a SPI/I2C bus). The off-chip electronic processor stores the current sensing data-in in a circular buffer 1504. The off-chip electronic processor has matching filtering (block 1506) to filter the incoming data to reduce noise and increase signal data integrity. The off-chip electronic processor sends the filtered data to perform data summation (block 1508) with an integration time (1510) input for the purpose of measurement accuracy and data integrity. At the same time, the off-chip electronic processor receives processed RGB image, IR image, or thermal image data (block 1512) and depth information (block 1512) (e.g., from ISP and TOF sensor, respectively) in which an indication of a potential living object is presented in the TOF sensor field-of-view (FOV) and within the laser safety hazard zone.

The off-chip electronic processor then retrieves a set of laser safety thresholds (block 1514) from the tabulated classifications (block 1516) and used as comparison criteria for laser current classification (1518) and laser safety action (block 1520). The logical laser safety actions include giving the user an audible or visible warning (block 1522) (e.g., tell the user the device is too close for usage), adapting laser emission energy reduction through programmable setting procedures and values (block 1524), or turning off the laser when a user ignores the audible or visible warning for the protection of the user and the user's subject (block 1526). When the off-chip electronic processor determines that no living object is detected in the TOF sensor field-of-view within laser safety hazard zone, the laser will continue to emit laser pulses above laser safety threshold values from the perspective of increasing detecting signal-to-noise ratio value and enhancing TOF depth measurement accuracy.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An electronic device comprising:
a memory storing a list of laser classifications and corresponding maximum permissible exposure (MPE) values;
a time-of-flight (TOF) sensor system including
a TOF sensor configured to generate depth information from light reflected of one or more objects, and
a laser configured to emit light pulses; and
an electronic processor configured to
control the laser to emit initial light pulses above a threshold emission level for a predetermined period of time,
receive the depth information that is generated by the TOF sensor, the depth information based on the initial light pulses emitted by the laser,
determine whether a living object is in a nominal hazard zone of the laser based on the depth information,
responsive to determining that the living object is not in the nominal hazard zone of the laser, control the laser to emit additional light pulses above the threshold emission level,
wherein the laser has a specific laser classification, and
wherein the threshold emission level is above an ANSI Z136.1 specification threshold emission level for the specific laser classification.

2. The electronic device according to claim 1, wherein, to determine whether the living object is in the nominal hazard zone of the laser based on the depth information, the electronic processor is further configured to
determine whether a living human is in the nominal hazard zone of the laser based on the depth information, and
responsive to determining that the living human is in the nominal hazard zone of the laser, control the laser to emit the additional light pulses below the threshold emission level.

3. The electronic device according to claim 1, wherein the electronic processor is further configured to determine whether a living human is in the nominal hazard zone of the laser with a neural network.

4. The electronic device according to claim 1, wherein the electronic processor is further configured to
receive the depth information for image processing and at least one of near-infrared image, a red-green-blue (RGB) image, or a thermal image, and
determine whether the living object is in the nominal hazard zone of the laser based on the depth information and the at least one of the near-infrared image, the red-green-blue (RGB) image, or the thermal image.

5. The electronic device according to claim 1, wherein, to control the laser to emit the additional light pulses above the threshold emission level, the electronic processor is further configured to
retrieve the specific laser classification of the laser from the memory,
determine the corresponding MPE values associated with the specific laser classification,
process the depth information with the corresponding MPE values to determine whether the depth information indicates that an energy level of the additional light pulses should be increased, decreased, or maintained relative to the initial light pulses, and
responsive to determining that the depth information indicates that the energy level of the additional light pulses should be increased, control the laser to emit the additional light pulses at an increased emission level relative to an emission level of the initial light pulses,
responsive to determining that the depth information indicates that the energy level of the additional light pulses should be decreased, control the laser to emit the additional light pulses at a reduced emission level relative to the emission level of the initial light pulses, and
responsive to determining that the depth information indicates that the energy level of the additional light pulses should be maintained, control the laser to emit the additional light pulses at the emission level of the initial light pulses.

6. The electronic device according to claim 1, wherein the laser is one of a single laser or a plurality of lasers forming an array of lasers.

7. The electronic device according to claim 6, wherein the laser is the plurality of lasers forming the array of lasers, and
wherein, to determine whether the living object is in the nominal hazard zone of the laser based on the depth information, the electronic processor is further configured to
determine whether a living human is in the nominal hazard zone of the laser based on the depth information,
responsive to determining that the living human is in the nominal hazard zone of the laser, generate coordinate bounding boxes of the living human,
responsive to generating the coordinate bounding boxes of the living human, identify a portion of the plurality of lasers that emit light in an area corresponding to the coordinate bounding boxes, and
control the portion of the plurality of lasers to emit the additional light pulses below the threshold emission level.

8. The electronic device according to claim 1, wherein, to control the laser to emit the initial light pulses above the threshold emission level for the predetermined period of time, the electronic processor is further configured to
retrieve a laser L-I curve from the memory, and
control the laser to emit the initial light pulses above the threshold emission level for the predetermined period of time based on the laser L-I curve.

9. The electronic device according to claim 1, further comprising:
an ambient light sensor configured to detect ambient light in an environment sensed by the TOF sensor,
wherein the electronic processor is further configured to
receive an ambient light detection value indicative of an amount of the ambient light detected in the environment from the ambient light sensor,
retrieve an eye pupil look-up table from the memory, and
select an eye pupil parameter based on the ambient light detection value, wherein the eye pupil parameter corresponds to an allowable laser light emission in the environment according to the ANSI Z136.1 specification threshold emission level for the specific laser classification.

10. The electronic device according to claim 1, further comprising:
a current sensing apparatus configured to measure and monitor a laser driver current of the laser,
wherein the current sensing apparatus is one of a shunt-based current-sensing circuit or non-radiometric magnetic sensing device.

11. A method comprising:
controlling, with an electronic processor, a laser to emit initial light pulses above a threshold emission level for a predetermined period of time;
receiving, with the electronic processor, depth information that is generated by a TOF sensor, the depth information based on the initial light pulses emitted by the laser;
determining, with the electronic processor, whether a living object is in a nominal hazard zone of the laser based on the depth information; and
responsive to determining that the living object is not in the nominal hazard zone of the laser, controlling, with the electronic processor, the laser to emit additional light pulses above the threshold emission level,
wherein the laser has a specific laser classification, and
wherein the threshold emission level is above an ANSI Z136.1 specification threshold emission level for the specific laser classification.

12. The method according to claim 11, wherein determining whether the living object is in the nominal hazard zone of the laser based on the depth information further includes
determining whether a living human is in the nominal hazard zone of the laser based on the depth information, and
responsive to determining that the living human is in the nominal hazard zone of the laser, controlling the laser to emit the additional light pulses below the threshold emission level.

13. The method according to claim 11, further comprising determining whether a living human is in the nominal hazard zone of the laser with a neural network.

14. The method according to claim 11, further comprising:
receiving the depth information for image processing or from one of near-infrared image, or a red-green-blue (RGB) image, or a thermal image; and
determining whether the living object is in the nominal hazard zone of the laser based on the depth information and the near-infrared image, or the red-green-blue (RGB) image, or the thermal image.

15. The method according to claim 11, wherein controlling the laser to emit the additional light pulses above the threshold emission level further includes
retrieving the specific laser classification of the laser from a memory,
determining the corresponding MPE values associated with the specific laser classification,
processing the depth information with the corresponding MPE values to determine whether the depth information indicates that an energy level of the additional light pulses should be increased, decreased, or maintained relative to the initial light pulses,
responsive to determining that the depth information indicates that the energy level of the additional light pulses should be increased, controlling the laser to emit the additional light pulses at an increased emission level relative to an emission level of the initial light pulses,
responsive to determining that the depth information indicates that the energy level of the additional light pulses should be decreased, controlling the laser to emit the additional light pulses at a reduced emission level relative to the emission level of the initial light pulses, and
responsive to determining that the depth information indicates that the energy level of the additional light pulses should be maintained, controlling the laser to emit the additional light pulses at the emission level of the initial light pulses.

16. The method according to claim 11, wherein the laser is one of a single laser or a plurality of lasers forming an array of lasers.

17. The method according to claim 13, wherein the laser is the plurality of lasers forming the array of lasers, and
wherein determining whether the living object is in the nominal hazard zone based on the depth information further includes
determining whether a living human is in the nominal hazard zone based on the depth information,
responsive to determining that the living human is in the nominal hazard zone, generating coordinate bounding boxes of the living human,
responsive to generating the coordinate bounding boxes of the living human, identifying a portion of the plurality of lasers that emit light in an area corresponding to the coordinate bounding boxes, and
controlling the portion of the plurality of lasers to emit the additional light pulses below the threshold emission level.

18. A non-transitory computer-readable medium comprising instructions that, when executed by an electronic processor, causes the electronic processor to perform a set of operations comprising:
controlling a laser to emit initial light pulses above a threshold emission level for a predetermined period of time;
receiving depth information that is generated by a TOF sensor, the depth information based on the initial light pulses emitted by the laser;
determining whether a living object is in a nominal hazard zone of the laser based on the depth information; and
responsive to determining that the living object is not in the nominal hazard zone of the laser, controlling the laser to emit additional light pulses above the threshold emission level,
wherein the laser has a specific laser classification, and
wherein the threshold emission level is above an ANSI Z136.1 specification threshold emission level for the specific laser classification.

19. The non-transitory computer-readable medium according to claim 19, wherein determining whether the living object is in the nominal hazard zone of the laser based on the depth information further includes
determining whether a living human is in the nominal hazard zone of the laser based on the depth information, and
responsive to determining that the living human is in the nominal hazard zone of the laser, controlling the laser to emit the additional light pulses below the threshold emission level.

20. The non-transitory computer-readable medium according to claim 19, further comprising:
receiving an ambient light detection value indicative of an amount of an ambient light detected in an environment from an ambient light sensor;
retrieving an eye pupil look-up table from the memory; and
selecting an eye pupil parameter based on the ambient light detection value,
wherein the eye pupil parameter corresponds to an allowable laser light emission in the environment according to the ANSI Z136.1 specification threshold emission level for the specific laser classification.
